(19) United States
(12) Patent Application Publication
(10) Pub. No.: US 2022/0284607 A1
(43) Pub. Date: Sep. 8, 2022

(54) METHOD FOR DETERMINING AND TRANSMITTING SLANT VISIBILITY RANGE INFORMATION, AND AIRCRAFT COMPRISING A SYSTEM FOR MEASURING A SLANT VISIBILITY RANGE

(71) Applicant: Airbus Operations (S.A.S.), Toulouse (FR)

(72) Inventor: Fabrice Bousquet, Toulouse (FR)

(21) Appl. No.: 17/682,577

(22) Filed: Feb. 28, 2022

(30) Foreign Application Priority Data
Mar. 4, 2021 (FR) 2102095

(51) Int. Cl. G06T 7/50; G06V 20/17; G06V 10/22; G08G 5/00; B64F 1/18; B64D 47/06

(52) U.S. Cl. CPC G06T 7/50; G06V 20/17; G06V 10/225; G08G 5/0013; B64F 1/18; B64D 47/06; G06T 2207/30256; G06T 2207/10032

(57) ABSTRACT

A method for determining and transmitting slant visibility range information for a runway at a predetermined decision altitude, including a step of acquiring, by a first aircraft, an image of a surrounding scene located outside and ahead of the aircraft, a step of analyzing the image to detect visual runway references in the image and measure distance between the aircraft and each detected runway reference, a step of transmitting slant visibility range information to the ground station, implemented by the first aircraft, the information including a distance between a visual runway reference and the aircraft measured in the analysis step if at least one runway reference has been detected, or if not information according to which no visual runway reference was able to be detected, and a step of transmitting, by the ground station, slant visibility range information associated with the runway to at least one second aircraft in flight.

### CROSS-REFERENCE TO RELATED APPLICATION

This application claims priority to French patent application number 2102095 filed on Mar. 4, 2021, the entire disclosure of which is incorporated by reference herein.

### TECHNICAL FIELD

The disclosure herein relates to a method for determining, by way of an aircraft, and for transmitting, by way of a ground station, slant visibility range information to aircraft in flight, and to an aircraft comprising a system for measuring a slant visibility range.

### BACKGROUND

With reference to FIG. 1, the pilots of an aircraft 1 wishing to make a visual approach towards a runway 2 of an airport that has been designated to them by air traffic control ATC have to have, at a predetermined altitude AD, called decision altitude, reached in the final approach segment, maximum visibility ahead of the aircraft SVR that is sufficient to clearly distinguish visual runway references (for example: approach lighting systems located in front of the runway, the runway boundary, or even the ground markings of the runway) and confirm to air traffic control that these visuals are actually visible.

Some events such as fog or a cloud ceiling P lower than the decision altitude AD may contribute to the pilots not being able to see the visual runway references at the decision altitude. The maximum visibility ahead of the aircraft SVR is commonly called slant visibility range in aeronautics.

If the pilots do not manage to distinguish the visual runway references at the decision altitude AD, they may make a new landing attempt, and if this proves to be unsuccessful, either search for a diversion solution to another airport or, if they are qualified for instrument approaches and the aircraft is equipped for such approaches, initiate an approach circuit towards the instruments of the runway. Each of these two alternatives not only delays the arrival time of the aircraft, which has abandoned the visual landing, but also impacts the flow of surrounding air traffic.

At present, the pilots of an aircraft 1 have no precise way of knowing, before starting the visual approach, whether they will be able to see the visual runway references at the decision altitude. Nevertheless, in order to help the pilots to anticipate the decision whether or not to commence the visual approach towards a runway, a ground station (air traffic control or another entity) provides two visibility indications to the aircraft 1, that is to say the value of the cloud ceiling P and the value of the runway visibility range (RVR) determined from measurements performed by a network of optical sensors 3 (transmissometers/light meters/devices for measuring the brightness of the runway beacons) arranged on the ground along the runway 2. The value of the runway visibility range RVR corresponds to the maximum distance at which it is possible for an operator on the ground to distinctly distinguish an object from the ground.

These visibility indications are relevant enough so that in most cases, if the value of the runway visibility range RVR and the ceiling value P are both greater than threshold values, there is a strong probability that the pilots will be able to distinctly see the visual runway references at the decision altitude AD. By contrast, for particular weather conditions, it may be the case that, even though the visibility indications are good, the pilots might not be able to see the visual runway markers at the decision altitude AD.

Such situations are harmful since they disrupt air traffic as mentioned above. To avoid such situations, there is a need to enrich the visibility indications given by the ground station with proven information for all weather conditions, so that the pilots are able to decide whether or not to continue the visual approach.

### SUMMARY

One aim of the disclosure herein is to address this need in full or in part. To this end, the disclosure herein relates to a method for determining, by way of an aircraft, and for transmitting, by way of a ground station, slant visibility range information for a runway at a predetermined altitude, called decision altitude, defined in the visual approach rules for the runway, the runway being provided with a plurality of visual runway references placed on the ground, the method comprising the following successive steps:
a step of acquiring, by way of a first aircraft equipped with a system for measuring the value of the slant visibility range, an image of a surrounding scene located outside and ahead of the aircraft, the scene possibly containing at least one visual runway reference, the image being acquired at the decision altitude and when approaching the runway;
a step of analyzing the image, implemented by the first aircraft, in which the system for measuring the value of the slant visibility range implements image processing algorithms in order to detect visual runway references in the image and measure the distance between the aircraft and each detected runway reference;
a step of transmitting slant visibility range information associated with the runway to the ground station, implemented by the first aircraft, the information comprising a distance between a visual runway reference and the aircraft measured in the analysis step if at least one runway reference has been detected, or if not information according to which no visual runway reference was able to be detected;
a step of transmitting, by way of the ground station, the slant visibility range information associated with the runway to at least one second aircraft in flight.

The disclosure herein also relates to an aircraft comprising flight sensors that are configured to measure flight parameters of the aircraft, the aircraft comprising a system for measuring the value of the slant visibility range comprising an image acquisition system arranged at the front of the aircraft and a computing device, the image acquisition system being configured to acquire an image of a surrounding scene located outside and ahead of the aircraft, the scene possibly containing at least one visual runway reference, and to generate a signal comprising data of the acquired image, the computing device receiving the signal generated by the image acquisition system at input and being configured to implement image processing algorithms in order, based on the signal and the flight parameters, to detect visual runway references in the image and measure the distance between the aircraft and each detected runway reference.

### BRIEF DESCRIPTION OF THE DRAWINGS

The abovementioned features of the disclosure herein, along with others, will become more clearly apparent upon reading the following description of one example embodiment, the description being given with reference to the appended drawings, in which:

FIG. 1, already described, is a schematic of an aircraft making a visual approach towards a runway of an airport;

FIG. 2 is a schematic view of an aircraft equipped with a system for measuring a value of the slant visibility range according to the disclosure herein;

FIG. 3 is a schematic view of the system for measuring the value of the slant visibility range fitted to the aircraft shown in FIG. 2;

FIG. 4 is a schematic view showing the steps of a method for determining and transmitting, by way of a ground station, slant visibility range information for a runway according to the disclosure herein.

### DETAILED DESCRIPTION

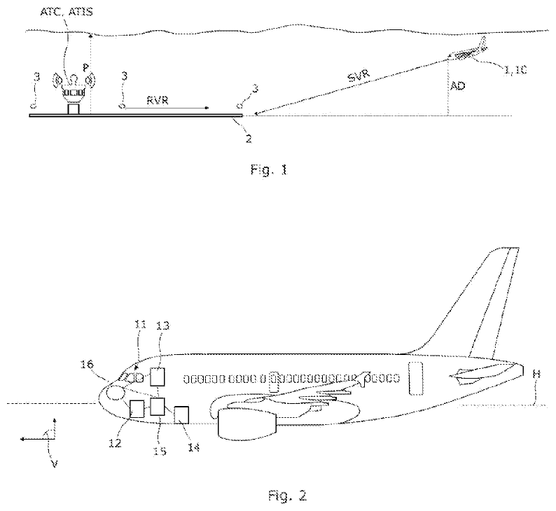

According to the disclosure herein and with reference to FIG. 2, at least one aircraft 10 is equipped to measure the value of the slant visibility range SVR for a runway 2. Using such an aircraft 10 that has measured the value of the slant visibility range SVR for a runway when it landed on the runway 2 then makes it possible for a ground station to transmit the slant visibility range information to other aircraft wishing to land on the runway 2 using a visual approach.

The aircraft 10 equipped to measure the value of the slant visibility range SVR for a runway comprises elements that are known from the prior art and that are fitted to all aircraft. These known elements are:
a cockpit 11, located at the front of the aircraft 10, containing a human-machine interface, display screens and loudspeakers (not shown in the figures);
communication device(s) 12 for exchanging signals between the aircraft 10 and entities outside the aircraft (that is to say other aircraft or ground stations). The communication device(s) 12 comprise radio communication devices (for example UHF or VHF) possibly supplemented with datalink devices;
flight sensors 13 configured to measure flight parameters of the aircraft 10 (roll, attitude, pitch, velocity, etc.);
a positioning system 14 (such as an inertial unit and/or GPS/GLONASS/GALILEO satellite positioning means) configured to determine the current position (geographical position and altitude) of the aircraft 10;
a flight management system 15 that collects the data from the flight sensors 13, the positioning system 14, and the instructions provided by the pilots of the aircraft via the human-machine interface, to ensure that a flight plan is followed to a destination runway on which the pilots have decided to land. The flight management system 15 comprises at least a computer and a memory unit (not shown) storing the flight plan of the aircraft 10, along with data regarding the airports and their runways (in particular the position and orientation of the runways). The flight management system 15 is furthermore connected to the display screens in order to display navigation information to the pilots.

It will be noted that, when the pilot wishes to make a visual approach towards an airport, the pilot contacts air traffic control ATC, requesting authorization to land at the airport with the type of approach the pilot desires (for example, visual approach VOR-DME). Air traffic control ATC, if it gives authorization to land, indicates the runway 2 in service. The pilot, via the human-machine interface, indicates the runway 2 to the flight management system 15 in order to guide the aircraft towards the runway 2, and also indicates the decision altitude AD associated with the runway that the pilot obtained by reading the visual approach rules for the runway, contained in a classifier or a touchscreen tablet at his disposal. When the aircraft 10 is flying over the final segment of the approach towards the runway 2, and upon crossing the decision altitude AD, the flight management system 15 emits, via a loudspeaker located in the cockpit, an acoustic alert “MINIMUM” for the attention of the pilot, telling him that the decision altitude AD has been crossed.

The aircraft 10 according to the disclosure herein furthermore comprises a system for measuring the value of the slant visibility range for a runway 16. The system for measuring the value of the slant visibility range for a runway 16 is connected to the sensors 13, to the flight management system 15, and to the communication device(s) 12 in order to transmit the slant visibility range SVR information to a ground station.

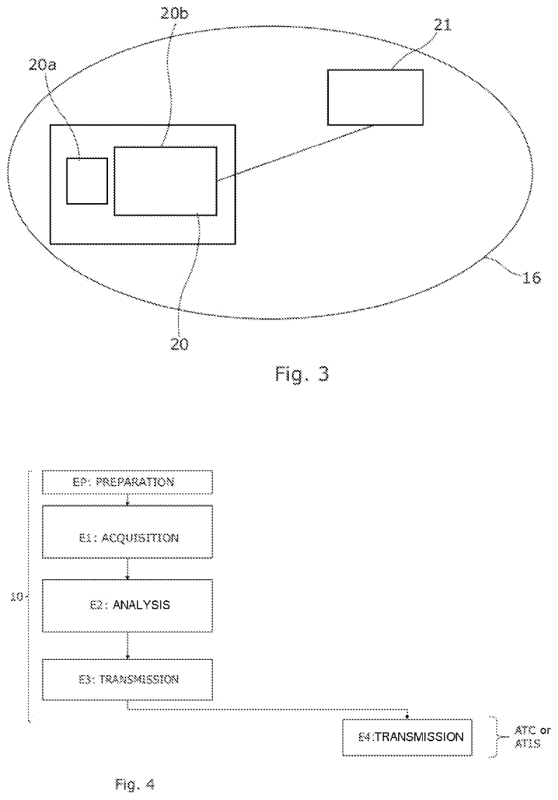

With reference to FIG. 3, the system for measuring the value of the slant visibility range for a runway 16 comprises an image acquisition device 20 and a computing device 21, the latter being a central processing unit with a processor and memories (not shown).

The image acquisition system 20 comprises a matrix optical sensor 20b associated with an optical image-forming system 20a.

The image acquisition system 20 is located at the front of the aircraft 10, either outside the aircraft (in this case, it is arranged on the nose of the aircraft or on the front part of a wing, that is to say on or close to the attack edge of the wing) or inside the aircraft (in this case, it is arranged in the cockpit 11 of the aircraft). The image acquisition system 20 is configured to acquire an image of a surrounding scene located outside and ahead of the aircraft 10, the scene possibly containing at least one visual runway reference. The optical sensor 20b generates a signal comprising data of the acquired image.

The optical image-forming system 20a is coupled to the optical sensor 20b and comprises at least one refractive lens, for example an objective-eyepiece system.

The features of the image acquisition system 20 are chosen such that it has detection capabilities similar to those of an emmetropic human eye and the same view that a pilot sitting on his seat in the cockpit would have.

Thus:
the image acquisition system 20 has a wide field of view;
the line of sight (normal to the plane of the optical sensor 20b) of the image acquisition system 20 is oriented substantially parallel to the horizontal plane H of the aircraft 10. It is preferably oriented substantially parallel to the median longitudinal plane V of the aircraft;
the image acquisition system 20 has a large field depth in order to acquire a crisp image over a wide region on either side of a focal plane;
the optical sensor 20b has a spectral sensitivity in the visible spectrum (400-750 nm) and a resolution suitable for resolving an object with a height of a few tens of centimetres, for example 30 cm, located at a distance of 1 km.

The computing device 21 receives the signal generated by the image acquisition system 20 at input and implements image processing algorithms in order, based on the signal, to detect visual runway references in the image and measure the distance between the aircraft 10 and each detected runway reference.

In detail, visual runway references are detected in the image by an object detection algorithm using a library of visual runway reference models (for example: lights on the approach ramp, lights on the runway boundary, runway boundary, touchdown area, etc.) stored in the memories of the computing device 21. An algorithm with a fast execution time, of less than one second, is used. The algorithm is for example based on the Viola and Jones method or is a YOLO, SSD or even Fast R-CNN algorithm.

Distance between a visual reference detected in the image and the aircraft 10 is measured by implementing a distance measurement algorithm that uses the following as input data:
the flight parameters provided by the flight sensors 13 (the altitude of the aircraft, the pitch angle of the aircraft, that is to say the angle between the horizontal plane of the aircraft H and the ground, which is considered flat),
the field of view of the optical sensor 20b, which is an invariable item of data stored in the memories of the computing device 21,
the distance in the image between the optical visual reference and the centre of the image.

A method for determining, by way of an aircraft equipped with a system for measuring the value of the slant visibility range for a runway 16, and for transmitting, by way of a ground station, slant visibility range information associated with a runway 2, will be described below with reference to FIG. 4.

In a preliminary action step EP, implemented when preparing the visual approach towards a runway 2, the pilot of the aircraft 10 equipped to measure a value of the slant visibility range 16 indicates, as parameters of the flight management system 15, both the runway 2 that has been assigned to him by air traffic control ATC and the decision altitude AD associated with the runway 2 for the approach under consideration by the pilot. Entering these two items of information activates the system for measuring the value of the slant visibility range 16.

In a first step E1, called acquisition step, the system for measuring the value of the slant visibility range 16 acquires an image of a surrounding scene located outside the aircraft 10, the scene possibly containing at least one visual runway reference. The acquisition of the image is ordered by the flight management system 15 when the aircraft 10 is on the final approach segment towards the runway 2 and at the decision altitude AD.

In a second step E2, called analysis step, the system for measuring the value of the slant visibility range 16 implements image processing algorithms in order to detect visual runway references in the image and measure the distance between the aircraft 10 and each detected runway reference.

At the end of this analysis step E2, the system for measuring the value of the slant visibility range 16 generates a signal comprising slant visibility range information, this information being:
the value of the slant visibility range SVR, which is the distance between the runway reference and the aircraft 10 if a single runway reference has been detected in the image, or which is the maximum distance measured between a runway reference and the aircraft 10 if multiple runway references have been detected in the image,
information according to which no visual runway reference was able to be detected.

Following analysis step E2, and in a step E3, called transmission step, the aircraft 10 transmits, via the communication device(s) 12, a signal comprising the slant visibility range information. The ground station is for example air traffic control ATC or an automatic terminal information service ATIS broadcast station that allows the pilots to receive live information about the runways at the airport with which the ATIS station is associated.

Following transmission step E3, and in a transmission step E4, the ground station transmits a signal to the one or more aircraft in flight whose communication device(s) are set to the frequency of the ground station. The signal comprises the slant visibility range information.

The signal received by the communication device(s) of an aircraft is either transcribed into a sound by the loudspeakers in the cockpit or transcribed in the form of information displayed on a screen in the cockpit.

If the ground station is air traffic control, the signal preferably comprises not only the slant visibility range information but also the value of the cloud ceiling P and the value of the runway visibility range RVR.

The disclosure herein makes it possible to enrich the two visibility indications already provided to the pilots by the ground station with slant visibility range information at the decision altitude AD.

With the slant visibility range information associated with the runway, the pilots have a reliable additional visibility indication allowing them to make a decision about whether or not it is possible to make a visual approach towards the runway 2.

The information will be all the more reliable as it is updated frequently, since aircraft will be equipped with systems for measuring the slant visibility value 16 as described above. Thus, upon each landing of an aircraft equipped with a system for measuring the slant visibility value 16 as described above, the method as described above is implemented.

In any scenario, that is to say whether or not a runway reference was able to be detected in search step E1, transmission step E4 is preferably implemented only for a predetermined duration after transmission step E3, in order to take into account any favourable changes in visibility. The duration is for example 10 minutes. Following this duration, the visibility range information determined by the aircraft 10 is no longer transmitted by the ground station.

If the ground station is air traffic control ATC, and in order not to overburden communications, air traffic control transmits the slant visibility range information only to aircraft to which it has designated the runway as landing runway for a visual approach.

While at least one example embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for determining, by way of an aircraft, and for transmitting, by way of a ground station, slant visibility range information for a runway at a predetermined decision altitude, defined in visual approach rules for the runway, the runway comprising a plurality of visual runway references placed on the ground, the method comprising successive steps of:
a step of acquiring, by way of a first aircraft equipped with a system for measuring a value of the slant visibility range, an image of a surrounding scene located outside and ahead of the aircraft, the scene possibly containing at least one visual runway reference, the image being acquired at the decision altitude and when approaching the runway;
a step of analyzing the image, implemented by the first aircraft, in which the system for measuring the value of the slant visibility range implements image processing algorithms to detect visual runway references in the image and measure a distance between the aircraft and each detected runway reference;
a step of transmitting slant visibility range information associated with the runway to the ground station, implemented by the first aircraft, the information comprising a distance between a visual runway reference and the aircraft measured in step of analyzing if at least one runway reference has been detected, or if not information according to which no visual runway reference was able to be detected; and
a step of transmitting, by way of the ground station, the slant visibility range information associated with the runway to at least one second aircraft in flight.

2. The method of claim 1, wherein the slant visibility range information comprises the maximum distance measured between a runway reference and the aircraft if multiple runway references are detected in the image.

3. The method of claim 1, wherein the step of transmitting is implemented only for a predetermined time starting after the step of transmitting has been implemented.

4. An aircraft comprising flight sensors configured to measure flight parameters of the aircraft, comprising a system for measuring a value of a slant visibility range comprising an image acquisition system arranged at a front of the aircraft and a computing device, the image acquisition device being configured to acquire an image of a surrounding scene located outside and ahead of the aircraft, the scene possibly containing at least one visual runway reference, and to generate a signal comprising data of the acquired image, the computing device receiving the signal generated by the image acquisition system at input and being configured to implement image processing algorithms in order, based on the signal and the flight parameters, to detect visual runway references in the image and measure a distance between the aircraft and each detected runway reference.

5. The aircraft of claim 4, wherein the image acquisition system comprises a matrix optical sensor with a sensitivity in a visible spectrum.

6. The aircraft of claim 5, wherein the image acquisition system comprises an optical image-forming system associated with the matrix optical sensor.

7. The aircraft of claim 4, wherein the image acquisition system has a line of sight oriented parallel to a horizontal plane of the aircraft.

8. The aircraft of claim 7, wherein the image acquisition system has a line of sight oriented parallel to a median longitudinal plane of the aircraft.

9. The aircraft of claim 4, wherein the aircraft comprises a cockpit, wherein the image acquisition system is in the cockpit of the aircraft.
